(19) United States
(12) Patent Application Publication
(10) Pub. No.: US 2003/0130990 A1
(43) Pub. Date: Jul. 10, 2003

(54) Method, apparatus, and program for enhancing the visibility of documents

(75) Inventors: Michael Wayne Brown, Georgetown, TX (US); Mark Joseph Hamzy, Round Rock, TX (US); Scott Thomas Jones, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/042,030

(22) Filed: Jan. 8, 2002

(51) Int. Cl. G06F 7/00

(52) U.S. Cl. 707/3

(57) ABSTRACT

A document viewer is provided with a clarification tool. The document viewer may be a Web browser and the clarification tool may be a plugin or extension. The clarification tool modifies the attributes of the document to make the text more visible. The manner in which the document attributes are modified may be defined in user preferences. For example, the user may choose to modify the color of the text to a predefined dark color or a predefined light color. As another example, the user may choose to remove the document background color or image. As a further example, the user may choose to display an outline or background around the text, such as white text on a black background or black text with a white outline. Other user defined or predefined methods for clarifying the text may also be used.

### BACKGROUND OF THE INVENTION

1. Technical Field

The present invention relates to data processing and, in particular, to document presentation. Still more particularly, the present invention provides a method, apparatus, and program for enhancing the visibility of documents.

2. Description of Related Art

The worldwide network of computers commonly known as the “Internet” has seen explosive growth in the last several years. Mainly, this growth has been fueled by the introduction and widespread use of so-called “Web browsers,” which enable simple graphical user interface-based access to network servers, which support documents formatted as so-called “Web pages.” These Web pages are versatile and customized by authors. For example, Web pages may mix text and graphic images. A web page also may include fonts of varying sizes and colors.

A browser is a program that is executed on a graphical user interface (GUI). The browser allows a user to seamlessly load documents from the Internet and display them by means of the GUI. These documents are commonly formatted using markup language protocols, such as hypertext markup language (HTML). Portions of text and images within a document are delimited by indicators, which affect the format for display. In HTML documents, the indicators are referred to as tags. The browser gives some means of viewing the contents of web pages (or nodes) and of navigating from one web page to another.

The versatility and customization of web pages, however, is sometimes an impediment to users displaying the documents. For example, documents, such as HTML documents, may allow the author to include a background image or color to be presented behind the document content. However, some authors choose backgrounds and colors that make the text blend into the background. Thus, when the document is presented on a display, the text may be difficult to read.

Some document viewers allow the user to define preferences for attributes of a document. For example, a user may be allowed to set a font typeface or size to define default attributes for documents that are displayed. These preferences may be used to enhance the visibility and readability of text. However, when attributes are explicitly specified, the explicit attributes in the document cannot be overridden. Thus, if the explicitly specified attributes render the document difficult to read, the user is helpless to change them.

Therefore, it would be advantageous to provide an improved document viewer that enhances the visibility of documents.

### SUMMARY OF THE INVENTION

The present invention provides a document viewer with a clarification tool. The document viewer may be a Web browser and the clarification tool may be a plugin or extension. The clarification tool modifies the attributes of the document to make the text more visible. The manner in which the document attributes are modified may be defined in user preferences. For example, the user may choose to modify the color of the text to a predefined dark color or a predefined light color. As another example, the user may choose to remove the document background color or image. As a further example, the user may choose to display an outline or background around the text, such as white text on a black background or black text with a white outline. Other user defined or predefined methods for clarifying the text may also be used.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A-4C are example screens of display for a document viewer in accordance with a preferred embodiment of the present invention;

FIG. 4D is an example screen of display for a preferences dialog in accordance with a preferred embodiment of the present invention;

FIGS. 5A-5C illustrate example documents in accordance with a preferred embodiment of the present invention;

FIG. 6 is an exemplary block diagram of a document viewing system with clarification in accordance with a preferred embodiment of the present invention;

FIG. 7 is a block diagram of a browser program in accordance with a preferred embodiment of the present invention; and

FIGS. 8 and 9 are flowcharts illustrating the operation of a document viewer in accordance with a preferred embodiment of the present invention.

### DETAILED DESCRIPTION OF THE PREFERRED EMBODIMENT

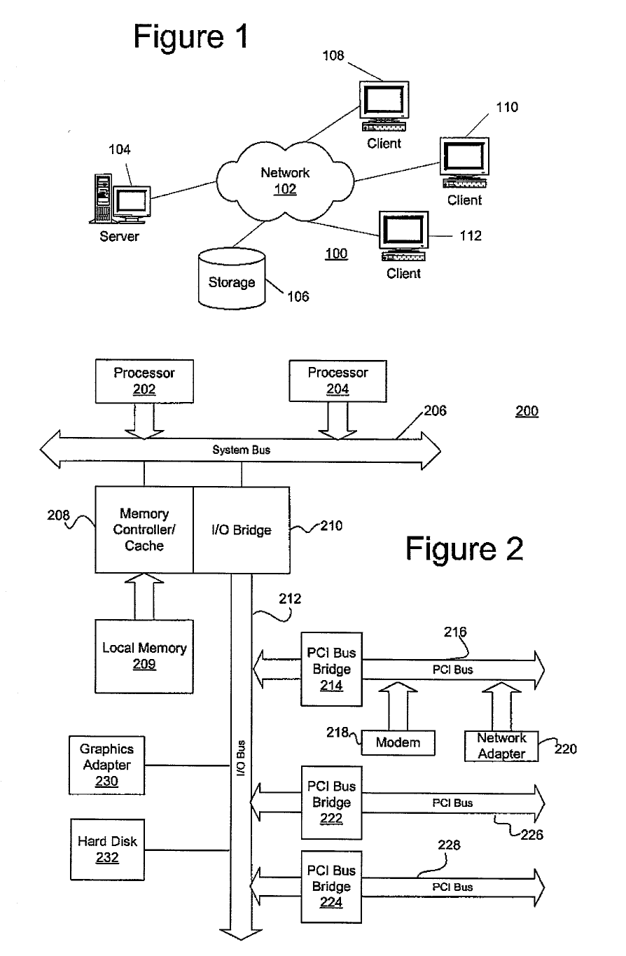

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

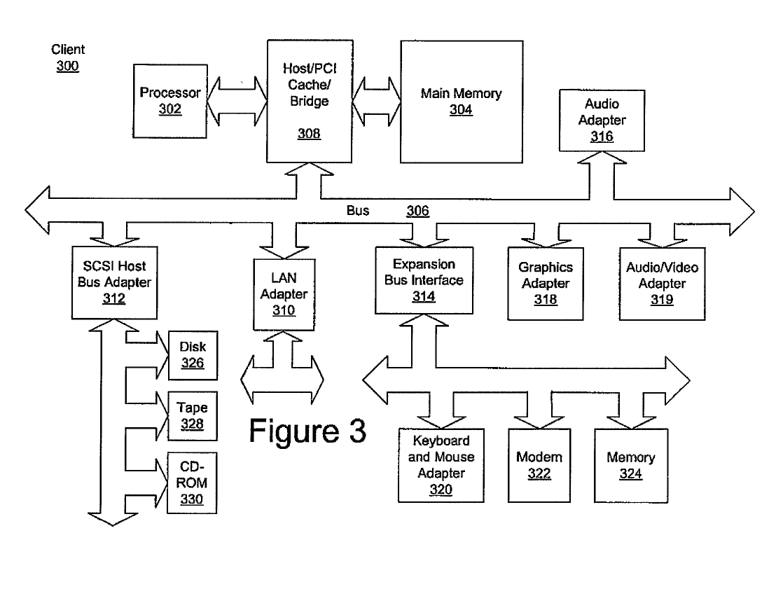

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

In accordance with a preferred embodiment of the present invention, data processing system 300 executes a document viewer. The document viewer is capable of displaying documents with background colors or images. The document viewer includes a clarification tool that modifies the attributes of the document to make the text more visible. Thus, if the text is obscured by background colors or images, the clarification tool may present the document with modified attributes to make the text more visible.

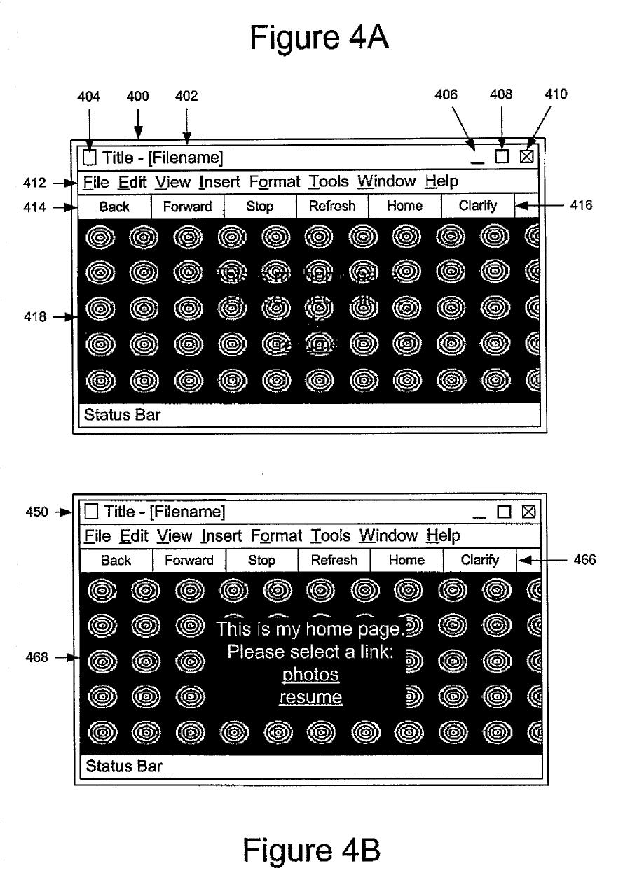

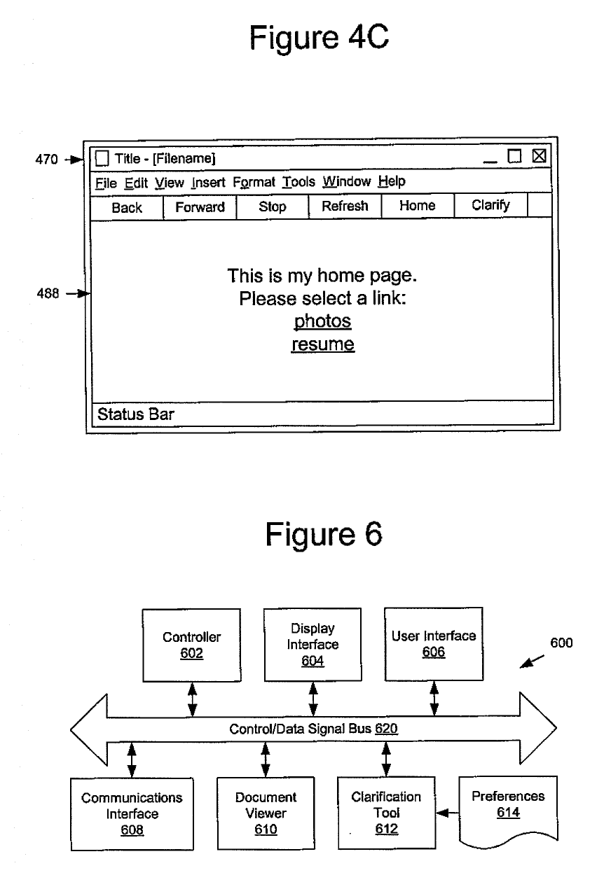

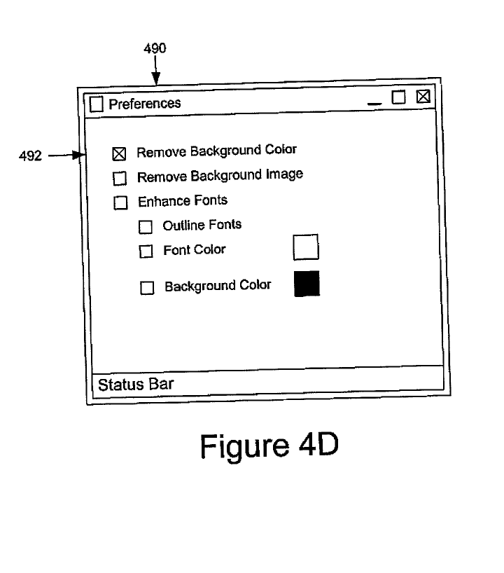

With reference to FIGS. 4A-4C, example screens of display for a document viewer are shown in accordance with a preferred embodiment of the present invention. Particularly, with respect to FIG. 4A, the screen comprises window 400, including a title bar 402, which may display the name of the application program. Title bar 402 also includes a control box 404, which produces a drop-down menu (not shown) when selected with the mouse, and “minimize” 406, “maximize” or “restore” 408, and “close” 410 buttons. The “minimize” and “maximize” or “restore” buttons 406 and 408 determine the manner in which the program window is displayed. In this example, the “close” button 410 produces an “exit” command when selected. The drop-down menu produced by selecting control box 404 includes commands corresponding to “minimize,” “maximize” or “restore,” and “close” buttons, as well as “move” and “resize” commands.

Document viewer window 400 also includes a menu bar 412 and navigation toolbar 414. Menus to be selected from menu bar 412 may include “File,” “Edit,” “View,” “Insert,” “Format,” “Tools,” “Window,” and “Help.”However, menu bar 412 may include fewer or more menus, as understood by a person of ordinary skill in the art. The navigation toolbar buttons include “Back”, “Forward”, “Stop”, “Refresh”, and “Home.” More particularly, navigation toolbar 414 may include “Clarify” button 416. A user may select the “Clarify” button to modify the attributes of the document to make the document text more visible.

The document viewer window also includes a display area 418 in which the document is presented. As can be seen in the example shown in FIG. 4A, the document displayed in display area 418 includes a background image that obscures the text and, thus, makes the text difficult to read.

Turning to FIG. 4B, document viewer window 450 includes display area 468 displaying the document with the clarification tool activated. The clarification tool may be activated or enabled by selecting and holding “Clarify” button 466 or may be toggled on and off by selecting “Clarify” button 466. Alternatively, the clarification tool may be enabled using menus in the menu bar or by selecting a menu item in a right-click menu, as known in the art.

In the example shown in FIG. 4B, the clarification tool clarifies the text by presenting light color text with a dark color background. Other methods for clarifying the text may be used, such as modifying the color of the text to a predetermined light color, removing the document background color or image, or displaying an outline around the text.

For example, with reference to FIG. 4C, document viewer window 470 includes display area 488 displaying the document with the clarification tool activated. In this example, the clarification tool clarifies the text by removing the document background image.

With reference to FIG. 4D, an example screen of display for a preferences dialog window is shown in accordance with a preferred embodiment of the present invention. Preferences dialog window 490 includes display area 492 displaying preferences that may be selected or defined for operation of the document viewer. For example, the user may select “Remove Background Color,” “Remove Background Image,” or “Enhance Fonts” in preferences dialog window 490. Furthermore, if “Enhance Fonts” is selected, the user may select to outline the fonts. The user may also define a font color and a background color to ensure that the text is displayed on a background with contrasting colors, thus making the text more readable.

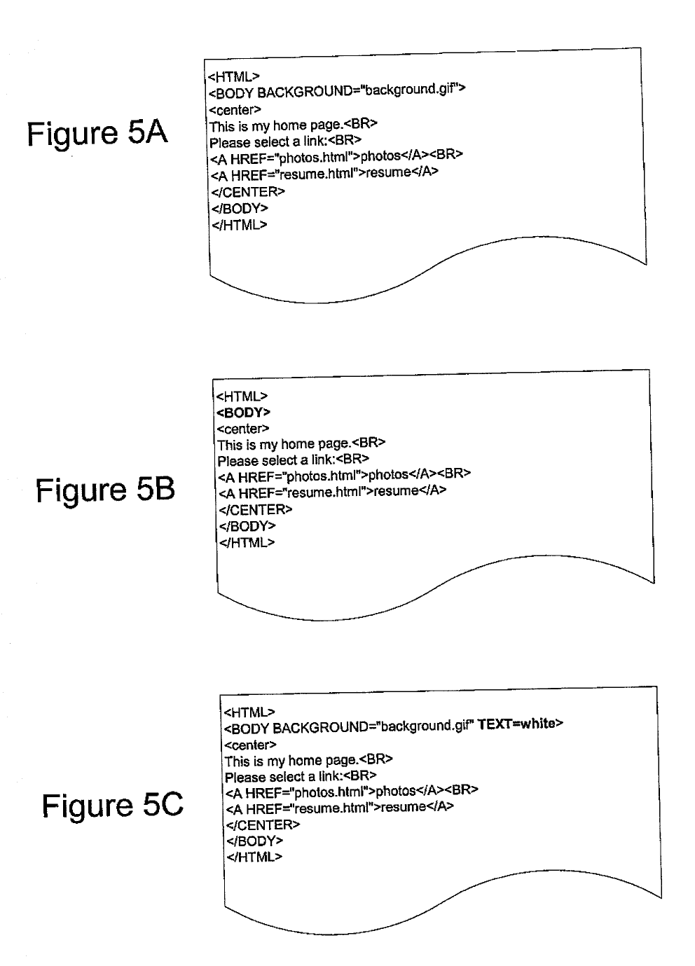

FIGS. 5A-5C illustrate example documents in accordance with a preferred embodiment of the present invention. Particularly, FIG. 5A illustrates an example HTML document as it is retrieved from storage or from a server. The BACKGROUND attribute in the BODY tag sets a background image as “background.gif.” The background image may be the image shown in FIG. 4A, wherein default black text may be difficult to read with the designated background image. The BODY tag may also designate a color, text color, link color, etc. For example, the BODY tag may include a BGCOLOR attribute. Text may be difficult to read if text color is set too close to the color of a background image or background color.

FIG. 5B illustrates an example HTML document that is modified to remove the background image. The BACKGROUND attribute is removed from the BODY tag. The resulting document may be similar to that shown in FIG. 4C. In an alternative implementation, user preferences may be set to modify text color to make the text more visible with respect to a background image or color. As shown in FIG. 5C, the BODY tag is modified to include a TEXT attribute to designate a text color.

FIG. 6 is an exemplary block diagram of a document viewing system with clarification in accordance with a preferred embodiment of the present invention. Document viewing system 600 includes a controller 602, a display interface 604, a user interface 606, a communications interface 608, a document viewer 610, and a clarification tool 612. The elements 602-612 may be implemented as hardware, software, or a combination of hardware and software. In a preferred embodiment, the elements 602-612 are implemented as software instructions executed by one or more processors.

The elements 602-612 are coupled to one another via the control/data signal bus 620. Although a bus architecture is shown in FIG. 6, the present invention is not limited to such. Rather, any architecture that facilitates the communication of control/data signals between elements 602-612 may be used without departing from the spirit and scope of the present invention. The controller 602 controls the overall operation of the document viewer and orchestrates the operation of the other elements 604-612.

With the operation of the present invention, document viewer 610 instructs controller 602 to display a document via display interface 604. The user interacts with the document viewer via user interface 606. Clarification tool 612, when enabled, clarifies text in a displayed document so that the text is more visible. Document viewer 610 may retrieve documents from a remote location. For example, the document viewer may be a Web browser. Thus, document viewing system 600 may receive documents to display from communications interface 608.

In accordance with a preferred embodiment of the present invention, clarification tool 612 modifies attributes of a document presented by document viewer 610. The manner in which the document attributes are modified may be defined by the user using the user interface. The user may select a clarification preferences, such as text color and background color, text color and outline color, whether to remove the background image, etc. These parameters may be stored in preferences 614 and clarification tool 612 may use the preferences to determine the attributes for the displayed document.

The clarification tool may be a plugin for a Web browser application or other document viewing application. Clarification tool 612 may modify a document by creating an intermediate modified document. The modified document may exist in memory or may be cached so the document viewer does not need to have the attributes modified every time the document is displayed. For example, if the document viewer is a Web browser, clarification tool 612 may be a proxy server that modifies documents before they are passed to the Web browser. Thus, Web pages may be modified by the clarification tool and cached. When a user returns to a page by hitting the “Back” button, for example, the modified document may be displayed without retrieving the document again.

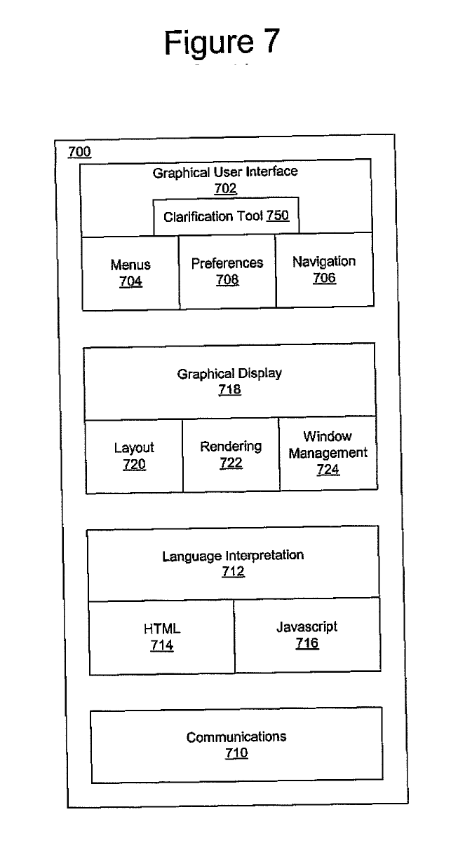

Turning next to FIG. 7, a block diagram of a browser program is depicted in accordance with a preferred embodiment of the present invention. A browser is an application used to navigate or view information or data in a distributed database, such as the Internet or the World Wide Web.

In this example, browser 700 includes a user interface 702, which is a graphical user interface (GUI) that allows the user to interface or communicate with browser 700. This interface provides for selection of various functions through menus 704 and allows for navigation through navigation 706. For example, menu 704 may allow a user to perform various functions, such as saving a file, opening a new window, displaying a history, and entering a uniform resource locator (URL). Navigation 706 allows for a user to navigate various pages and to select web sites for viewing. For example, navigation 706 may allow a user to see a previous page or a subsequent page relative to the present page. Preferences such as those illustrated in FIG. 7 may be set through preferences 708. Graphical user interface 702 also includes clarification tool 750 for modifying document attributes to make the document text more visible.

Communications 710 is the mechanism with which browser 700 receives documents and other resources from a network such as the Internet. Further, communications 710 is used to send or upload documents and resources onto a network. In the depicted example, communication 710 uses HTTP. Other protocols may be used depending on the implementation. Documents that are received by browser 700 are processed by language interpretation 712, which includes an HTML unit 714 and a JavaScript unit 716. Language interpretation 712 will process a document for presentation on graphical display 718. In particular, HTML statements are processed by HTML unit 714 for presentation while JavaScript statements are processed by JavaScript unit 716.

Graphical display 718 includes layout unit 720, rendering unit 722, and window management 724. These units are involved in presenting web pages to a user based on results from language interpretation 712.

Browser 700 is presented as an example of a browser program in which the present invention may be embodied. Browser 700 is not meant to imply architectural limitations to the present invention. Presently available browsers may include additional functions not shown or may omit functions shown in browser 700. A browser may be any application that is used to search for and display content on a distributed data processing system. Browser 700 may be implemented using known browser applications, such Netscape Navigator or Microsoft Internet Explorer. Netscape Navigator is available from Netscape Communications Corporation while Microsoft Internet Explorer is available from Microsoft Corporation.

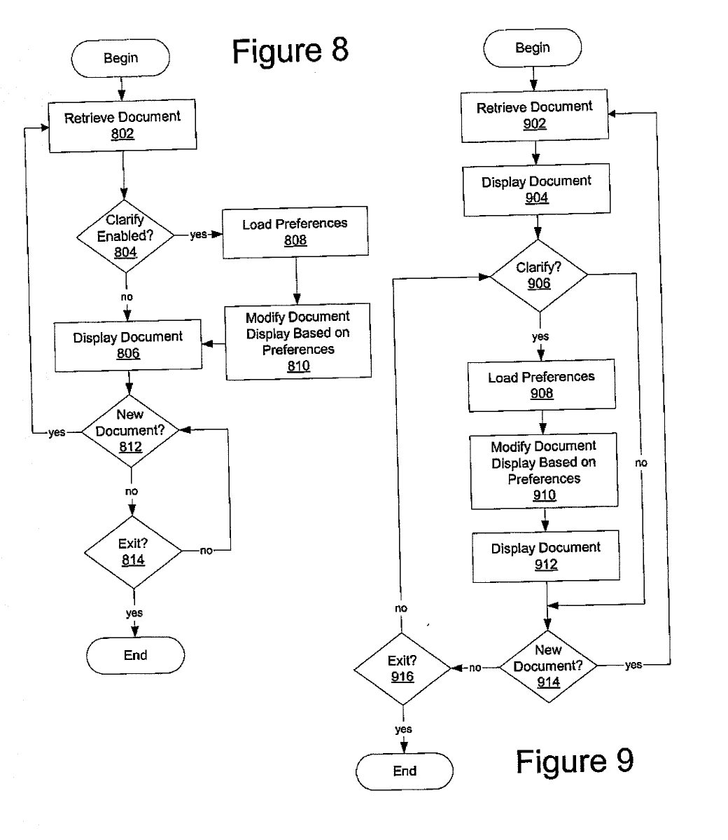

With reference now to FIGS. 8 and 9, flowcharts illustrating the operation of a document viewer are shown in accordance with a preferred embodiment of the present invention. Particularly, with respect to FIG. 8, the process begins and retrieves a document (step 802). Then, a determination is made as to whether clarify is enabled (step 804). If clarify is not enabled, the process displays the document (step 806). If clarify is enabled, the process loads preferences (step 808) and modifies the document display based on the preferences (step 810). Thereafter, the process proceeds to step 806 to display the document.

After the document is displayed, a determination is made as to whether a new document is to be loaded (step 812). If a new document is to be loaded, the process returns to step 802 to retrieve the document. If, however, a new document is not to be loaded in step 812, a determination is made as to whether an exit condition exists (step 814). If an exit condition exists, the process ends. If an exit condition does not exist in step 814, the process returns to step 812 to determine whether a new document is to be loaded.

Turning to FIG. 9, an alternative process is shown. The process begins, retrieves the document (step 902), and displays the document (step 904). A determination is made as to whether the clarification tool is activated (step 906). If the user determines that the text of a document is not sufficiently visible, the user activates the clarification tool and the process loads preferences (step 908), modifies the document display based on the preferences (step 910) and redisplays the document (step 912). Next, a determination is made as to whether a new document is to be loaded (step 914).

If the clarification tool is not activated in step 906, the process proceeds to step 914 to determine whether a new document is to be loaded. If a new document is to be loaded, the process returns to step 902 to retrieve the document. If a new document is not to be loaded in step 914, a determination is made as to whether an exit condition exists. If an exit condition does not exist, the process returns to step 906 to determine whether the clarification tool is activated. If an exit condition does exists in step 916, the process ends.

Thus, the present invention solves the disadvantages of the prior art by providing a convenient tool for clarifying documents that are designed or authored with text that is difficult to read. The clarification tool is capable of modifying document attributes so that text is more visible. The clarification tool also allows the document display to be modified based upon user preferences, thus allowing the user to define a clarification method. In an alternative embodiment, the document may be encoded such that at least a portion of the text is obscured by a background and the text cannot be read without the clarification tool. In this embodiment, the clarification tool may also authenticate the identity of a user before modifying the attributes of the document.

The clarification tool overrides explicitly specified attributes for components in a document. Therefore, even if the document is poorly designed and difficult to read, the clarification tool can modify the explicitly specified attributes for enhanced display. Furthermore, the clarification tool of the present invention may be especially useful for users with visual impairment, such as color blindness. For example, while blue text on a green background might be readable to most users, a person with visual impairment may not be able to read the text. As another example, a person with a visual impairment may have difficulty reading fine print in documents. The clarification tool of the present invention can be used to enhance the display of the fine print.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for clarifying a document, comprising:
retrieving a document including a document component having an attribute, wherein the attribute is explicitly specified in the document; and
modifying the attribute to enhance display of the document.

2. The method of claim 1, further comprising displaying the document.

3. The method of claim 1, wherein the document component comprises a background image and the step of modifying the attribute comprises removing the background image from the document.

4. The method of claim 1, wherein the document component comprises a background color and the step of modifying the attribute comprises changing the background color.

5. The method of claim 1, wherein the document component comprises text and the step of modifying the attribute comprises changing a color of the text in the document.

6. The method of claim 1, further comprising:
determining whether a clarification tool is enabled,
wherein the step of modifying the attribute is in response to the clarification tool being enabled.

7. The method of claim 6, further comprising:
displaying the document before determining whether the clarification tool is enabled.

8. The method of claim 7, wherein the step of determining whether a clarification tool is enabled comprises determining whether the clarification tool is activated by a user.

9. The method of claim 1, further comprising:
loading user preferences.

10. The method of claim 9, wherein the step of modifying the attribute comprises modifying the attribute based on the user preferences.

11. The method of claim 1, further comprising:
authenticating a user, wherein the step of modifying the attribute comprises modifying the attribute in response to the user being authenticated.

12. The method of claim 1, wherein the step of modifying the attribute comprises creating an intermediate modified document.

13. The method of claim 12, further comprising displaying the intermediate modified document.

14. An apparatus for clarifying a document, comprising:
retrieval means for retrieving a document including a document component having an attribute, wherein the attribute is explicitly specified in the document; and
modification means for modifying the attribute to enhance display of the document.

15. The apparatus of claim 14, wherein the document component comprises a background image and the modification means comprises means for removing the background image from the document.

16. The apparatus of claim 14, wherein the document component comprises a background color and the modification means comprises means for changing the background color.

17. The apparatus of claim 14, wherein the document component comprises text and modification means comprises means for changing a color of the text in the document.

18. The apparatus of claim 14, further comprising:
determination means for determining whether a clarification tool is enabled,
wherein the modification means modifies the attribute in response to the clarification tool being enabled.

19. The apparatus of claim 18, wherein the determination means comprises means for determining whether the clarification tool is activated by a user.

20. The apparatus of claim 14, further comprising:
means for loading user preferences.

21. The apparatus of claim 20, wherein the modification means comprises means for modifying the attribute based on the user preferences.

22. The apparatus of claim 14, further comprising:
authentication means for authenticating a user, wherein the step of modifying the attribute comprises modifying the attribute in response to the user being authenticated.

23. The apparatus of claim 14, wherein the modification means comprises means for creating an intermediate modified document.

24. A document viewing system comprising:
a document viewer;
a selectable clarification tool; and
a controller, coupled to the document viewer and the selectable clarification tool, wherein the controller retrieves a document; wherein the clarification tool, when selected, causes the controller to modify attributes of the document to form a modified document, wherein display of text in the modified document is enhanced relative to the document; and wherein the document viewer causes the controller to display the modified document.

25. A computer program product, in a computer readable medium, for clarifying a document, comprising:
instructions for retrieving a document including a document component having an attribute, wherein the attribute is explicitly specified in the document; and
instructions for modifying the attribute to enhance display of the document.
